(19) United States
(12) Patent Application Publication
(10) Pub. No.: US 2025/0202646 A1
(43) Pub. Date: Jun. 19, 2025

(54) SYNCHRONIZATION SIGNAL BLOCK FOR MULTI-BEAM COMMUNICATION WITH LARGE ANTENNA ARRAYS

(71) Applicant: Lenovo (United States) Inc., Morrisville, NC (US)

(72) Inventor: Colin FRANK, Park Ridge, IL (US)

(21) Appl. No.: 19/067,195

(22) Filed: Feb. 28, 2025

(51) Int. Cl. H04L 5/00; H04W 72/044; H04W 72/0446; H04W 72/0453

(52) U.S. Cl. CPC H04L 5/0048; H04W 72/0446; H04W 72/0453; H04W 72/046

(57) ABSTRACT

Various aspects of the present disclosure relate to a base station configured to or operable to simultaneously transmit at least one synchronization signal block (SSB) over a plurality of beams, using same time and frequency resources, in accordance with a transmit diversity scheme, within a near field of an antenna array.

### TECHNICAL FIELD

The present disclosure relates to wireless communications, and more specifically to performing wireless communication of at least one synchronization signal block (SSB) over a plurality of beams using a transmit diversity scheme within a near field of an antenna array.

### BACKGROUND

A wireless communications system may include one or multiple network communication devices, otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

An NE (e.g., a base station) for wireless communication is described. The NE may be configured to, capable of, or operable to perform one or more operations as described herein. For example, the NE may be configured to, capable of, or operable to simultaneously transmit at least one synchronization signal block (SSB) over a plurality of beams, using same time and frequency resources, in accordance with a transmit diversity scheme, within a near field of an antenna array.

In some implementations of the method and apparatuses described herein, the transmit diversity scheme is Space Frequency Block Coding (SFBC), and wherein the SFBC is exclusively applicable for a Physical Broadcast Channel (PBCH) associated with the at least one SSB.

In some implementations of the method and apparatuses described herein, each of the plurality of beams is associated with an SFBC port.

In some implementations of the method and apparatuses described herein, the NE may be configured to transmit, for each of the plurality of beams, a Primary Synchronization Signal (PSS) of the at least one SSB using at least on set of time and frequency resources of at least two sets of time and frequency resources, wherein each set of time and frequency resources is different.

In some implementations of the method and apparatuses described herein, the NE may be configured to select the at least one set of time and frequency resources based at least in part on an SFBC port associated with each respective beam of the plurality of beams.

In some implementations of the method and apparatuses described herein, the at least two sets of time and frequency resources are associated with one or more same time resources and different frequency resources, the time resources comprise one or more symbols or slots, and the frequency resources comprise one or more frequency sub-bands or frequency bands.

In some implementations of the method and apparatuses described herein, the at least two sets of time and frequency resources are associated with one or more same frequency resources and different time resources, the frequency resources comprise one or more frequency sub-bands or frequency bands, and the time resources comprise one or more symbols or slots.

In some implementations of the method and apparatuses described herein, the NE may be configured to transmit, for each beam of the plurality of beams, a Secondary Synchronization Signal (SSS) of the at least one SSB using at least one set of time and frequency resources of at least two sets of time and frequency resources, wherein each set of time and frequency resources is different.

In some implementations of the method and apparatuses described herein, the NE may be configured to select the at least one set of time and frequency resources based at least in part on an SFBC port associated with each respective beam of the plurality of beams.

In some implementations of the method and apparatuses described herein, the at least two sets of time and frequency resources are associated with one or more same time resources and different frequency resources, the time resources comprise one or more symbols or slots, and the frequency resources comprise one or more frequency sub-bands or frequency bands.

In some implementations of the method and apparatuses described herein, the at least two sets of time and frequency resources are associated with one or more same frequency resources and different time resources, the frequency resources comprise one or more frequency sub-bands or frequency bands, and the time resources comprise one or more symbols or a slots.

### BRIEF DESCRIPTION OF THE DRAWINGS

FIG. 1 illustrates an example of a wireless communications system in accordance with aspects of the present disclosure.

FIG. 2 illustrates an example of transmission between an antenna at a transmitter and an antenna array at a receiver in accordance with aspects of the present disclosure.

FIG. 3 illustrates an example of beam amplitudes at four different focusing distances as a fraction of the Fraunhofer distance in accordance with aspects of the present disclosure.

FIG. 4 illustrates an example of phases of the beams in FIG. 3 in accordance with aspects of the present disclosure.

FIG. 5 illustrates an example of SFBC coding for two symbols S0 and S1 in two resource elements in accordance with aspects of the present disclosure.

FIG. 6 illustrates an example of SFBC coding for six symbols in six resource elements in accordance with aspects of the present disclosure.

FIG. 7 illustrates an example of transmitting different beams within the same angular region using alternating SFBC ports in accordance with aspects of the present disclosure.

FIG. 8 illustrates an example of transmitting different beams to different azimuths at the same distance using alternating SFBC ports in accordance with aspects of the present disclosure.

FIG. 9 illustrates an example of transmitting different beams to different azimuths and different distances using alternating SFBC ports in accordance with aspects of the present disclosure.

FIG. 10 illustrates an example of port assignments for symbols and resource elements using SFBC and FSTD in accordance with aspects of the present disclosure.

FIG. 11 illustrates an example of transmitting beams using SFBC and FSTD in accordance with aspects of the present disclosure.

FIG. 12 illustrates an example of an SSB in 5G NR.

FIGS. 13 and 14 illustrates examples of allocating time and frequency resources for the transmission of the PSS and SSS in accordance with aspects of the present disclosure.

FIGS. 15 and 16 illustrate examples of transmitting the PSS and SSS of an SSB for different port assignments in accordance with aspects of the present disclosure.

FIGS. 17 and 18 illustrate examples of transmitting the PSS and SSS of an SSB using different port assignments in accordance with aspects of the present disclosure.

FIG. 19 illustrates an example of a UE in accordance with aspects of the present disclosure.

FIG. 20 illustrates an example of a processor in accordance with aspects of the present disclosure.

FIG. 21 illustrates an example of a NE in accordance with aspects of the present disclosure.

FIG. 22 illustrates a flowchart of method performed by a NE in accordance with aspects of the present disclosure.

### DETAILED DESCRIPTION

In a wireless communication system, one or more of a NE and UE may support beamforming for wireless communication. For example, a NE and/or a UE may be configured with one or more antennas, antenna panels, and/or antenna arrays to support wireless communication. The one or more antennas, antenna panels, and/or antenna arrays may be arranged to support beamforming or other beamformed communications. In some cases, it has been observed that beams formed using a large antenna array within a near field of the antenna array may exhibit a narrow beamwidth in both azimuth (θ) and range. This enables a NE (e.g., a base station, such as a gNB) to use the same time and frequency resources to simultaneously transmit separate information (e.g., data) to two UEs located at the same azimuth θ relative to the NE but at different distances r₁ and r₂. This is achieved by forming two distinct beams, one focused at range r₁ and azimuth θ, and the other at range r₂ and θ.

Beam focusing, however, presents some challenges. First, if a UE is located in the near field of the antenna array, the distance of the UE has to be accurately determined to ensure proper beam focusing. Otherwise, any inaccuracies in the distance determination may cause the beam to miss the UE (e.g., the beam does not properly align with the actual location of the UE, resulting in a significant degradation or complete loss of the transmission received by the UE). Second, in some cases where the NE transmits system information intended for all UEs in a given direction, irrespective of their distance from the NE, a single focused beam cannot effectively reach all UEs. This limitation arises because beam focusing inherently targets specific ranges, making it unsuitable for wider range beamformed communication.

To address the above challenges, various aspects of the present disclosure may support transmission of the same information (e.g., data) on multiple beams. However, when these beams overlap, there is a risk that the overlapping beams may interfere destructively by adding out of phase, resulting in nulls or regions of poor coverage. To mitigate or eliminate beam cancellation in the overlap regions and ensure constructive power addition (e.g., the beams add in power), space frequency block coding (SFBC) or SFBC and frequency switched transmit diversity (FSTD) may be used to transmit data on multiple beams, thereby enhancing the reliability and coverage of the transmissions.

In some examples, the NE may select a sufficient number of beams to ensure coverage of a region (also referred to as a target region, a target zone). For SFBC transmissions, each beam may be assigned (e.g., allocated) to one of two SFBC ports (e.g., antenna ports), which may be referred to as port 0 and port 1. Similarly, for SFBC and FSTD transmissions, each beam may be assigned two ports from a set of ports. When assigning beams to ports, the assignment may be optimized to reduce or minimize the overlap between beams that transmit on the same port, thereby decreasing the risk of interference and improving reliability of the transmissions.

Accordingly, various aspects of the present disclosure may enable a NE (e.g., a base station) to perform transmission of the same information (e.g., data) to one or more UEs located within the near field of an antenna array using multiple ports, even in cases where the precise distance of the UEs is not known. The NE and the one or more UEs may support beam search and beam selection, which may involve the NE periodically transmitting a synchronization signal blocks (SSB) to one or more UEs, which may scan for the SSB and demodulate a physical broadcast channel (PBCH) before initiating a connection on a random access channel (RACH). However, when many near-field beams are present, sequentially transmitting the SSB on each beam becomes impractical. According to aspects of the present disclosure, each beam transmitting the SSB may be assigned to one of two ports, allowing simultaneous transmission of the SSB on multiple beams. The PBCH may be transmitted on these beams using SFBC and decoded by the UEs. Additionally, different time and frequency resources may be allocated for the primary synchronization signal (PSS) and secondary synchronization signal (SSS) transmitted from the two sets of ports. The UEs may scan both time and frequency resources associated with the PSS and the SSS, combine the received measurements of the SSB, and extract cell information (e.g., a cell identifier and the like) for synchronization with the NE.

Aspects of the present disclosure are described in the context of a wireless communications system.

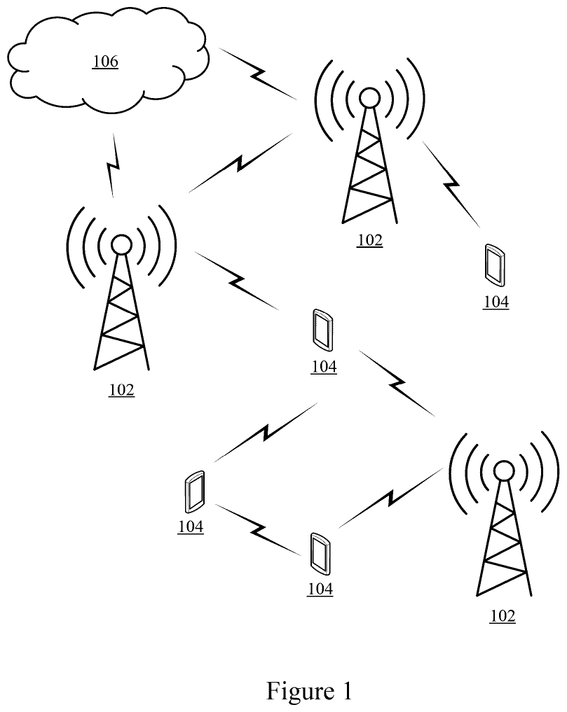

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

For antenna arrays with a large number of antenna elements, such as antenna arrays that are feasible for millimeter wave (mmWave) transmission, a significant portion of the coverage region may be within the near-field region of the arrays. These arrays exhibit two characteristics: (1) the beams are very narrow (e.g., very narrow beamwidth), and (2) the beams have a limited depth of focus (e.g., the beams maintain their intended beamforming properties only within a specific range).

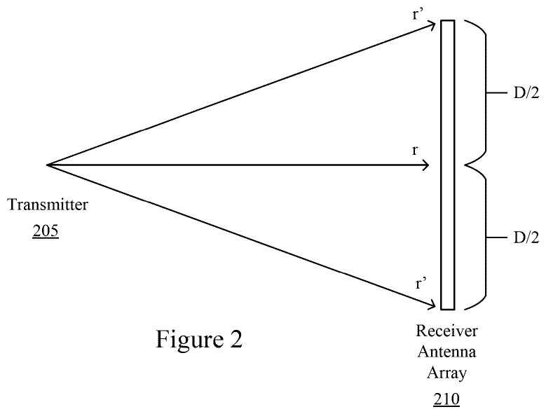

FIG. 2 illustrates an example of transmission in accordance with aspects of the present disclosure. In the example of FIG. 2, the transmission may involve a single antenna at a transmitter 205 (e.g., an NE 102, a UE 104) and an antenna array at a receiver 210 (e.g., an NE 102, a UE 104), or conversely, an antenna array at the transmitter 205 and a single antenna at the receiver 210, D represents the length of the antenna array 210, while and r denotes the distance between the center of the antenna array 210 and the single antenna 205, as shown in FIG. 2.

To ensure that the receiver 210 (e.g., an NE 102, a UE 104) is within the far-field of the transmitter, the distance r′-r, should satisfy the condition:

$$\frac{2 π}{λ} ( {r}^{′} - r ) \leq \frac{π}{8}$$

which is equivalent to the requirement:

$$\frac{2 π}{λ} \frac{{D}^{2}}{8 d} \leq \frac{π}{8} ⇒ r \geq \frac{2 {D}^{2}}{λ}$$

If the antenna array is not perpendicular to the line connecting the center of the transmitter 205 to the center of the receiver, the far-field condition is satisfied when:

$$r \geq \frac{2 {D}^{2} {sin}^{2} θ}{λ}$$

where θ is the angle between the line connecting the center of the transmitter 205 and the center of the receiver 210 and a line parallel to the antenna array.

When antenna arrays are present at both the transmitter 205 and the receiver 210, with respective lengths D₁ and D₂, and the arrays are perpendicular to the line connecting the center of the transmitter and receiver arrays, the far-field condition is satisfied (e.g., applies) for distances r such that:

$$r \geq \frac{2 ( {D}_{1}^{2} + {D}_{2}^{2} )}{λ} .$$

If the arrays are not perpendicular to the line connecting the centers of the transmitter 205 and receiver array 210, the far-field condition applies for distances r satisfying:

$$r \geq \frac{2 ( {D}_{1}^{2} {sin}^{2} {θ}_{1} + {D}_{2}^{2} {sin}^{2} {θ}_{2} )}{λ} ,$$

where θ₁ and θ₂ are represent the angles between the line connecting the centers of the transmitter 205 and receiver 210, and lines parallel to the transmitter and receiver arrays.

When a UE 104 is in the near field, the far-field approximations, where the phase of the received signal is assumed to change linearly across the receiver array, are no longer accurate. In the near-field region, the distance between a transmitter element and receiver antenna array can be expressed using the law of cosines as:

$$\vert z - {s}_{n} \vert = \sqrt{{r}^{2} + {n}^{2} {d}^{2} - 2 rnd cos θ}$$

where: z denotes the position of the receiver, sₙ denotes the position of the transmitter element, r is the distance between the center of the transmitter array and the UE 104, d is the spacing of the antenna elements, n is the index of the transmitter antenna element relative to the center of the array, and θ is the angle between the line containing the transmitter elements and the line from the center of the array to the receiver. Using a second-order Taylor series expansion, the distance can be approximated as:

$$\vert z - {s}_{n} \vert \approx r - nd cos θ + \frac{{n}^{2} {d}^{2} sin θ}{2 r} .$$

This approximation provides a more accurate representation of the signal propagation characteristics in the near-field region.

When the transmitter includes N+1 antenna elements, where N is an even integer, the weighting coefficients applied to the transmitter antenna elements may be represented as:

$${a}_{n} = exp ( j {φ}_{n} ) , n = - N / 2 , N / 2$$

Assuming a line-of-sight channel, the antenna array pattern at the UE 104 is given by:

$$β \cdot {\sum }_{n = - N / 2}^{N / 2} \frac{{a}_{n}}{{\vert z - {s}_{n} \vert}^{2}} {e}^{- j \frac{2 π}{λ} \vert z - {s}_{n} \vert} \approx β \cdot {\sum }_{n = - N / 2}^{N / 2} \frac{{e}^{- j ( \frac{2 π}{λ} ( r - nd cos θ + \frac{{n}^{2} {d}^{2} sin θ}{2 r} ) - {φ}_{n} )}}{{\vert z - {s}_{n} \vert}^{2}}$$

where β is a constant. In the uniform power region, the distance

|z−sₙ|²

is approximately independent of n, so that the antenna array pattern at the UE 104 can be approximated as:

$$g ( r , θ , {\{ {φ}_{n} \}}_{n = 1}^{N} ) = β {r}^{- 2} {\sum }_{n = - N / 2}^{N / 2} {e}^{- j ( \frac{2 π}{λ} ( r - nd cos θ + \frac{{n}^{2} {d}^{2} sin θ}{2 r} ) - {φ}_{n} )}$$

To maximize the array gain at a given r₁ and θ₁, the conjugate matched phases aₙ=exp(j φₙ) are given by:

$${φ}_{n} = \frac{2 π}{λ} ( {r}_{1} - nd cos {θ}_{1} + \frac{{n}^{2} {d}^{2} sin {θ}_{1}}{2 {r}_{1}} )$$

Resulting in a peak gain:

$$g ( r , θ , \{ {φ}_{n} \} ) = ( N + 1 ) β {r}_{1}^{- 2} .$$

With these same coefficients, the gain at range r₂ is given by

$$β {r}_{2}^{- 2} {\sum }_{n = - N / 2}^{N / 2} {e}^{j \frac{2 π}{λ} ( {r}_{1} - {r}_{2} + {n}^{2} {d}^{2} sin {θ}_{1} ( \frac{1}{{r}_{1}} - \frac{1}{{r}_{2}} ) )} = β {r}_{2}^{- 2} {e}^{j \frac{2 π}{λ} ( {r}_{1} - {r}_{2} )} {\sum }_{n = - N / 2}^{N / 2} {e}^{j \frac{2 π}{λ} ( \frac{1}{{r}_{1}} - \frac{1}{{r}_{2}} ) ( {n}^{2} {d}^{2} sin {θ}_{1} )} .$$

If d=λ/2, then the antenna array pattern is given by

$$= β {r}_{2}^{- 2} {e}^{j \frac{2 π}{λ} ( {r}_{1} - {r}_{2} )} {\sum }_{n = - N / 2}^{N / 2} {e}^{j \frac{πλ {n}^{2} sin {θ}_{1}}{2} ( \frac{1}{{r}_{1}} - \frac{1}{{r}_{2}} )} .$$

Let \hat{r} denote the distance normalized by the Fraunhofer array distance so that

$$\hat{r} = {r ( \frac{2 {D}^{2} {sin}^{2} θ}{λ} )}^{- 1} = {r ( \frac{2 {( N λ / 2 )}^{2} {sin}^{2} θ}{λ} )}^{- 1} = \frac{2 r}{{N}^{2} {λsin}^{2} θ} ,$$

where for the near-field approximations to apply, it must be that \hat{r}≤1. With the normalized distances \hat{r}₁ and \hat{r}₂, the array pattern is given by

$$β {r}_{2}^{- 2} {e}^{j \frac{2 π}{λ} ( {r}_{1} - {r}_{2} )} {\sum }_{n = - N / 2}^{N / 2} {e}^{j \frac{πλ {n}^{2} sin {θ}_{1}}{2} \frac{2}{{N}^{2} λ {sin}^{2} {θ}_{1}} ( \frac{1}{{\hat{r}}_{1}} - \frac{1}{{\hat{r}}_{2}} )} = β {r}_{2}^{- 2} {e}^{j \frac{2 π}{λ} ( {r}_{1} - {r}_{2} )} {\sum }_{n = - N / 2}^{N / 2} {e}^{j \frac{π}{{sin θ}_{1}} ( \frac{1}{{\hat{r}}_{1}} - \frac{1}{{\hat{r}}_{2}} ) {( \frac{n}{N} )}^{2}}$$

According to (1), beam focusing occurs in the region where r is less than one-tenth the Fraunhofer array distance. If we consider an example in which \hat{r}₁=0.05 and \hat{r}₂=0.1, this becomes

$$= β {r}_{2}^{- 2} {e}^{j \frac{2 π}{λ} ( {r}_{1} - {r}_{2} )} {\sum }_{n = - N / 2}^{N / 2} {e}^{j \frac{10 π}{{sin θ}_{1}} {( \frac{n}{N} )}^{2}}$$

Here, the complex exponents in the summation take values in the interval [0, 2.5 π/sin θ₁) so that the terms do not add coherently. Thus, a beam for which the phases of the transmit array elements adds coherently at \hat{r}₁=0.05 does not add coherently at \hat{r}₂=0.1.

The optimized array weighting coefficients optimized for a given range r* and angle θ* can be expressed as:

$${a}_{n} ( {r}^{*} , {θ}^{*} ) = exp ( j {φ}_{n} ( {r}^{*} , {θ}^{*} ) ) , n = - N / 2 , N / 2$$

where:

$${φ}_{n} ( {r}^{*} , {θ}^{*} ) = \frac{2 π}{λ} ( {r}^{*} - nd cos {θ}^{*} + \frac{{n}^{2} {d}^{2} sin {θ}^{*}}{2 {r}^{*}} )$$

The antenna response at a range r and angle θ for an array which is the conjugate phase match for range r* and angle θ* is given by:

$$g ( r , θ , \{ {φ}_{n} ( {\hat{r}}^{*} , {θ}^{*} ) \} ) = β {r}^{- 2} {e}^{j \frac{2 π}{λ} ( {r}^{*} - r )} {\sum }_{n = - N / 2}^{N / 2} {e}^{j \frac{π}{{sin θ}_{1}} ( \frac{1}{{\hat{r}}^{*}} - \frac{1}{\hat{r}} ) {( \frac{n}{N} )}^{2}} .$$

By normalizing the gain by the path loss term from the transmitter to the center of the array, the normalized array gain is:

$${g}_{N} ( r , θ , \{ {φ}_{n} ( {\hat{r}}^{*} , {θ}^{*} ) \} ) = {\sum }_{n = - N / 2}^{N / 2} {e}^{j \frac{π}{{sin θ}_{1}} ( \frac{1}{{\hat{r}}^{*}} - \frac{1}{\hat{r}} ) {( \frac{n}{N} )}^{2}} .$$

The amplitude of the normalized gain of the beams formed by the antenna array is shown in FIG. 2 for θ=π/2 (perpendicular to the array) and N=101 for values of \hat{r}* in the set {0.02, 0.04, 0.06, 0.08} and for \hat{r} in the range 0≤\hat{r}≤1.

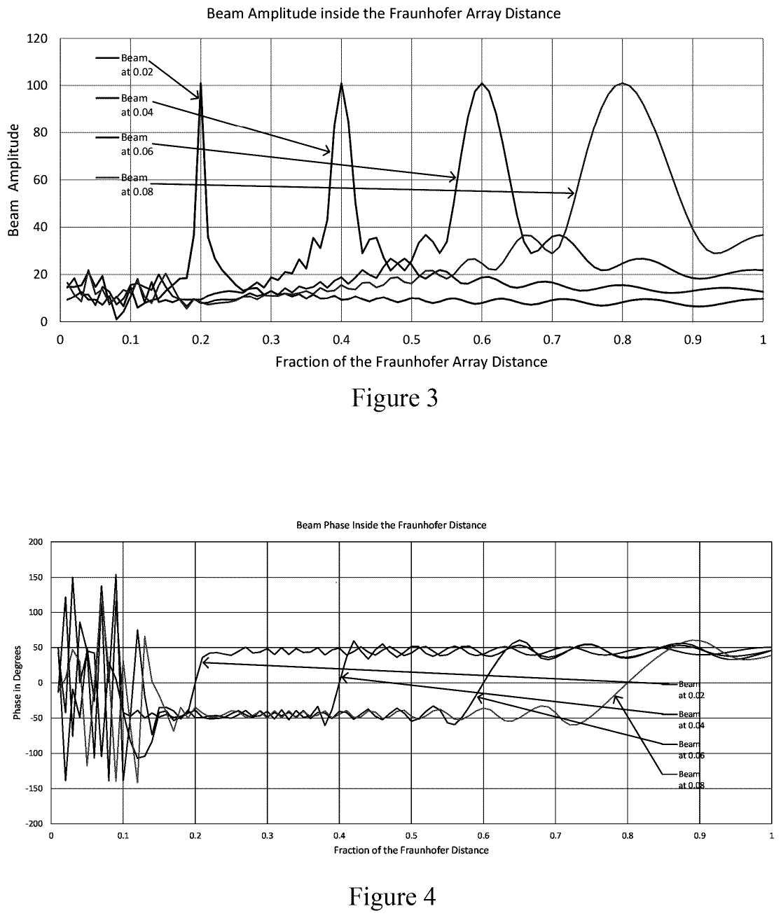

FIG. 3 illustrates an example of beam amplitudes at four different focusing distances as a fraction of the Fraunhofer distance, or within the near field of a transmitter, and FIG. 4 illustrates an example of the phases of the beams in FIG. 3. The term “near field” may refer to areas within the Fraunhofer distance of an array. In FIG. 3, it is apparent that the widths of the beams are quite narrow in range and increase as the value of the beam peak \hat{r}* is increased. From FIG. 4, it can be seen that the beam phase changes by 100 degrees from slightly before the peak until slightly after.

The behavior shown in FIG. 3 in the near field of the array is referred to as beam focusing. This beam focusing behavior has benefits, but also some drawbacks. The benefit of beam focusing is that it allows a transmitter to use the same time and frequency resources to transmit independent data simultaneously to receivers (e.g., UEs 104) lying in the same azimuth θ relative to the transmitter, but with different distances r₁ and r₂ by using two separate beams with the first focused at range r₁ and azimuth θ the second focused at range r₂ and θ. The ability to transmit independent data streams simultaneously to two receivers lying in the same azimuth with the same time and frequency resources does not exist in the far-field of the array since the array gain is constant in the far-field of the array and does not depend on distance.

Conventional beam focusing has at least two significant limitations. First, if a UE 104 is in the near field of the transmitter, the UE's 104 distance has to be accurately determined to ensure proper beam focusing. If the distance is not precisely known, the beam may not align correct with the UE 104, resulting in degradation or loss of communication with the UE 104. As illustrated in FIG. 3, the focus distance of beams is relatively narrow, especially at distances close to the transmitter.

Second, in some cases, such as the transmission of system information block (SIB) or a master information block (MIB), a NE 102 (e.g., base station, such as gNB) may need to transmit or broadcast the same information to multiple UEs 104 in a given direction, regardless of their individual distances from the NE 102. In such cases, a single beam cannot effectively cover all UEs 104 that are within the near field of a transmitting antenna array. It should be understood that various examples of base stations equipped with transmit antenna arrays may implement aspects of the present disclosure. Both of these limitations are especially problematic for large transmitter arrays and higher frequency signals.

For an Extremely Large Aperture Array (ELAA), the number of beams can be very large. For example, considering a dual polarized array with a size 2×3 meters at 2.4 GHz with half-wavelength spacing, the number of antenna elements is approximately 3200. As a result, there will be a large number of beams in both azimuth and in distance. Another example is an array in which there are 256 angular beams and 20 distance beams for a total of 5120 near field beams and this makes the beam selection problem very complicated.

The problem is exacerbated for higher frequency radio waves. Accordingly, embodiments of the present disclosure may be especially helpful for transmitting frequencies 2 GHz or greater, frequencies of 2.4 GHz or greater, frequencies of 3 GHz or greater, frequencies of 5 GHz or greater, or millimeter waves (e.g. frequencies of 30 GHz and above). In some embodiments, frequencies of up to 80 GHz may be transmitted. However, lower frequency transmissions are also within the scope of this disclosure including transmitting at frequencies below 2 GHz.

In addition, embodiments may be helpful when applied to transmit antenna arrays such as massive MIMO arrays and ELAA arrays, arrays with 100 or more antenna elements, arrays with 500 or more antenna elements, and arrays with 1000 or more antenna elements. In such arrays, depending on the frequency, the near field can extend to distances as large as 30 to 500 meters, for example. Since a base station is preconfigured with antenna elements and transmit frequencies and the size of a near field is proportional those features, the base station may know the size of a near field for associated transmissions.

In a similar manner as demonstrated above, it can be shown that the beams in the near field of the array are narrow in azimuth, and this leads to the same benefits and drawbacks identified for beams which are narrow in range. Thus, a base station may use the same time and frequency resources to transmit independent data simultaneously to users at the same distance r from the base station but with closely spaced azimuths θ₁ and θ₂ by focusing a first beam at distance r and azimuth θ₁ and a second beam at distance r and azimuth θ₂. However, the same drawbacks as for beam focusing at distance r also apply to beam focusing in azimuth θ.

First, if the UE 104 is the near field, the azimuth of the UE 104 must be known accurately to properly focus the beam. Otherwise, the beam will miss the UE 104. Second, in some cases, for example when transmitting system information, a base station would like to transmit the same information to all of the UEs 104 in a given range, regardless of the azimuth from the base station. In this case, a single beam cannot be used to transmit to all UEs 104.

Thus, while beam focusing with very narrow beams can be beneficial from the perspective of reducing multi-user interference and allowing the reuse of time and frequency resources, there are cases such as when there is insufficient knowledge of the location of one or more UE 104 or when data is to be transmitted to multiple UEs simultaneously, when wider beams are needed or would be beneficial.

One solution to this problem is to transmit the same signal on multiple beams focused in the same azimuth but at different distances r. Alternatively, the same signal can be transmitted on multiple beams focused at the same distance but at different azimuths. In addition, beams may be transmitted over a range of distances and azimuths. However, since the beams will have significant overlap, there is some question as to how the beams will add in phase, especially since the phases of the beams change rapidly near the beam peak as is shown in FIG. 4. As a result, it may be difficult to control the beam pattern in distance, even if the beams are independently phased.

The optimal outcome when beams are overlapped is that they add in power, and this can be achieved by using space-frequency block coding (SFBC) or space-time block coding (STBC) using the Alamouti method.

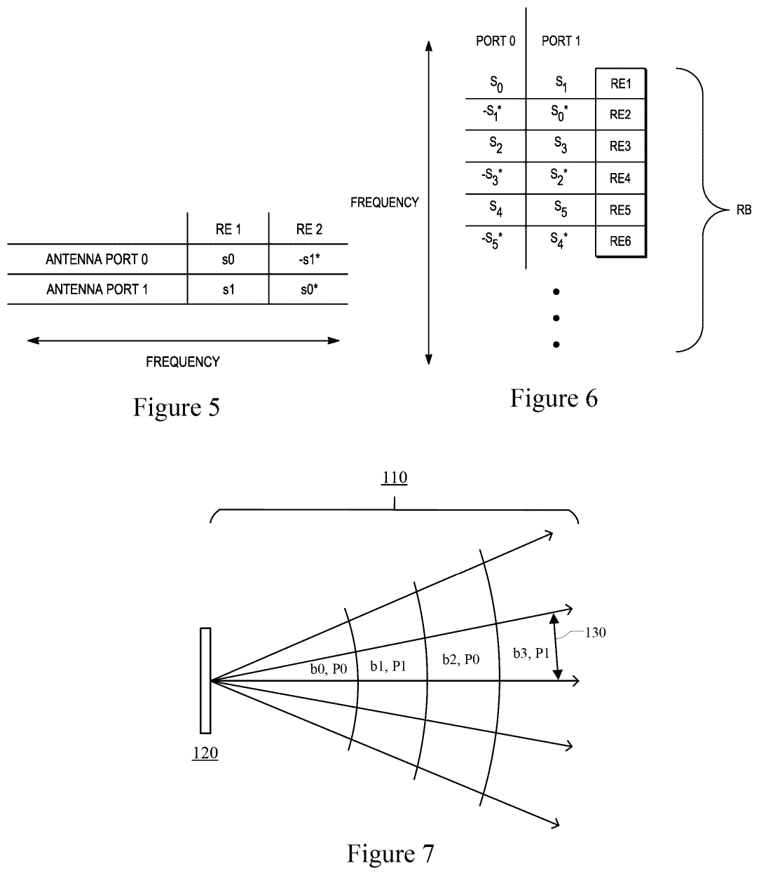

SFBC uses at least two antenna ports. FIG. 5 illustrates an example of SFBC coding for two symbols S0 and S1 in two resource elements in accordance with aspects of the present disclosure, and FIG. 6 illustrates an example of SFBC coding for six symbols in six resource elements in accordance with aspects of the present disclosure.

The port assignment for additional symbols in FIG. 6 may be the same as the port assignment shown in FIG. 5. For example, in RE3, symbol S₂ may be assigned port 0 and symbol S₃ may be assigned port 1, etc. Each of the ports may be SFBC ports, and each symbol may be transmitted on two antenna ports.

In FIGS. 5 and 6, the symbols s₀ and s₁ are transmitted from ports 0 and 1 simultaneously on resource element RE1. Similarly, symbols −s₁* and s₀* (the negative complex conjugate and complex conjugate of symbols s₀ and s₁) are transmitted from ports 0 and 1 simultaneously on resource element RE2. g₀ and g₁ denote the complex channel gains from ports 0 and 1 to a receiver (e.g. a UE 104) respectively. The signals received by a UE 104 for resources elements RE1 and RE2 are given by y₁ and y₂ given by

$${y}_{1} = {g}_{0} {s}_{0} + {g}_{1} {s}_{1} + {n}_{1}$$

$${y}_{2} = - {g}_{0} {s}_{1}^{*} + {g}_{1} {s}_{0}^{*} + {n}_{2}$$

where n₁ and n₂ denote independent complex Gaussian random variables such that Σ|n₁|²=E|n₂|²=σ² and E(n₁*n₂)=0.

The symbols s₀ and s₁ can be estimated as

$${\hat{s}}_{0} = {g}_{0}^{*} {y}_{1} + {g}_{1} {y}_{2}^{*} = ( {\vert {g}_{0} \vert}^{2} + {\vert {g}_{1} \vert}^{2} ) {s}_{0} + {g}_{0}^{*} {n}_{1} + {g}_{1} {n}_{2}^{*}$$

and that

$${\hat{s}}_{1} = {g}_{1}^{*} {y}_{1} - {g}_{0} {y}_{2}^{*} = ( {\vert {g}_{0} \vert}^{2} + {\vert {g}_{1} \vert}^{2} ) {s}_{1} + {g}_{1}^{*} {n}_{1} - {g}_{0} {n}_{2}^{*} .$$

From these two equations, it can be observed that each of the symbols is received with the sum power of the two channels given by |g₀|²+|g₁|² and that this is true regardless of the phases of the complex channel gains g₀ and g₁ from the two beams to the UE 104.

It can also be noted that the variance of the noise terms are equal and given by

$$E {\vert {g}_{0}^{*} {n}_{1} + {g}_{1} {n}_{2}^{*} \vert}^{2} = E {\vert {g}_{1}^{*} {n}_{1} - {g}_{0} {n}_{2}^{*} \vert}^{2} = ( {\vert {g}_{0} \vert}^{2} + {\vert {g}_{0} \vert}^{2} ) {σ}^{2}$$

so that the signal-to-noise ratios of the two symbol estimates are equal.

FIG. 7 illustrates an example of transmitting different beams within the same angular region 130 using alternating SFBC ports in accordance with aspects of the present disclosure. In FIG. 7, the horizontal axis represents horizontal distance from an antenna array 120, and the vertical axis represents angular distance or azimuth. The antenna array 120 may be a transmitter of an NE 102 such as a transmit antenna array of a base station such as a gNB. The spaces between the arrows radiating from antenna array 120 represent angular regions 130 of beams which are transmitted from the antenna array. The beams in FIG. 7 may use the same port assignments shown in FIGS. 5 and 6 such that the same data is transmitted simultaneously on multiple beams.

FIG. 7 shows four different beams b0, b1, b2 and b3 which are in the near field 110 of the antenna array 120. For operation in the near field 110 of the array 120, each antenna port may be mapped to a beam, and the ports may be assigned to beams in an alternating manner with respect to distance from the antenna array 120. For example, a first port P0 is mapped to beam b0 at a first distance from the antenna array 120, a second port P1 is mapped to beam b1 which is a second distance which is greater than the first distance from the antenna array 120, the first port P0 is also mapped to beam b2 which is a third distance greater than the second distance from the antenna array 120, and the second port P1 is also mapped to beam b3 which is a fourth distance greater than the third distance from the antenna array 120. The same alternating mapping of two ports may continue at further distances from the antenna array 120 for consecutive beams. Accordingly, two ports can be re-used in an alternating manner across multiple beams at a fixed azimuth with varying distance as indicated in FIG. 7 so that beams cover the indicated angular region 130.

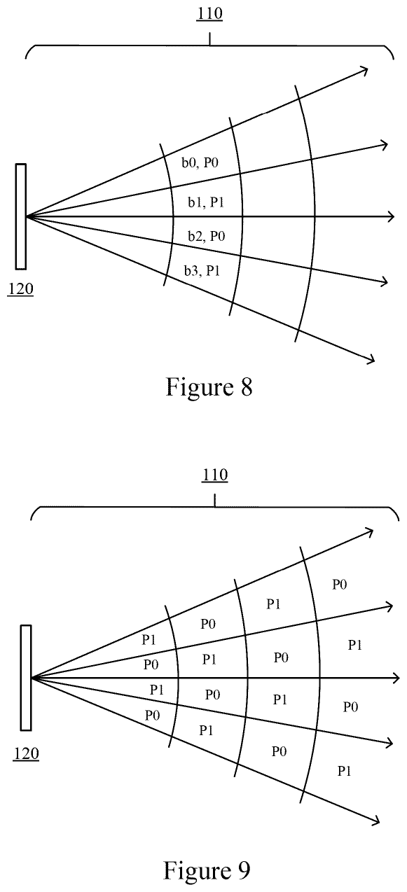

FIG. 8 illustrates an example of transmitting different beams to different azimuths at the same distance using alternating SFBC ports in accordance with aspects of the present disclosure. In FIG. 8, four different beams b0, b1, b2 and b3 are each transmitted to a different respective azimuth, each of which is about the same distance from the antenna array 120, and port assignments for the beams alternate between P0 and P1. Each of the ports may be SFBC ports.

FIG. 9 illustrates an example of transmitting different beams to different azimuths and different distances using alternating SFBC ports in accordance with aspects of the present disclosure. The embodiment of FIG. 9 combines features of the embodiments of FIGS. 7 and 8 by transmitting a plurality of beams with alternating port assignments to different azimuths and distances within the near field 110 of antenna array 120. Each azimuth/distance sector receives a different beam, resulting in a total of 16 beams. The port assignments of the beams alternate according to azimuth and distance, so that adjacent beams have different port assignments. The number of beams in FIG. 9 (as well as FIGS. 7 and 8) is merely an example, and other numbers of beams are possible.

In some embodiments, more than one transmit diversity scheme may be used to transmit beams in the near field 110 of a transmitter 120. For example, SFBC may be combined with another transmit diversity scheme such as frequency switched transmit diversity (FSTD) to increase the probability that beams add in power and do not cancel in regions in which they overlap.

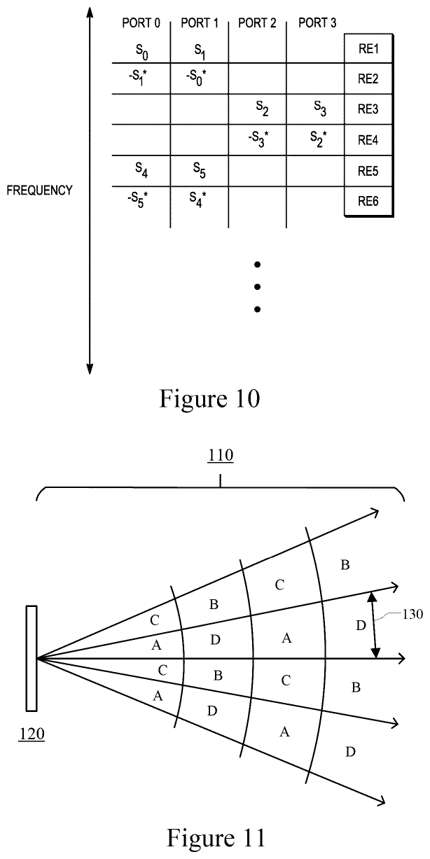

FIG. 10 illustrates an example of port assignments for symbols and resource elements using SFBC and FSTD, and FIG. 11 illustrates an example of transmitting beams using SFBC and FSTD in accordance with aspects of the present disclosure.

In an embodiment, the combination of SFBC and FSTD may be used with four antenna ports with only two antenna ports transmitting on any particular resource element. In order to apply SFBC and FSTD in this scenario, the four antenna ports may be partitioned into four sets of two ports given by A={port 0, port 2}, B={port 0, port 3}, C={port 1, port 2}, and D={port 1, port 3}. In this example, each pair of ports includes one port from ports 0 and 1 and one port from ports 2 and 3. Accordingly, a beam which is used to transmit any one of these port sets will transmit all four of the data symbols {s₀, s₁, s₂, s₃} so that a UE 104 receiving any one of the beams can demodulate and decode the transmission. Larger numbers of ports and other combinations of port assignments are possible in other embodiments.

As shown in FIG. 11, each of the beams is assigned one of the four sets of ports. The beams and their respective ports are distributed in space to minimize regions in which beams are adjacent to other beams with the same port assignment (e.g., a beam assigned port 0 next to another beam assigned port 0) since it is in these regions that beams can add out of phase and cancel. With the use of both SFBC and FSTD and the defining of four sets of two antenna ports, it is less likely that a beam assigned with one set of ports will be adjacent to another beam assigned the same set of ports, and as a result, there is less opportunity for beams canceling when out of phase.

### Multi-Beam Transmission of SSB

Beam search and beam selection is typically accomplished using a Synchronization Signal Block (SSB) signal, which is transmitted periodically by a base station. A UE 104 scans for the SSB and demodulates the Physical Broadcast Channel (PBCH) before the UE can initiate a connection on a Random Access Channel (RACH). In the case of 5120 near field beams of an ELAA described above, the process of sequentially transmitting the SSB on each of 5120 beams is too time consuming to be practical.

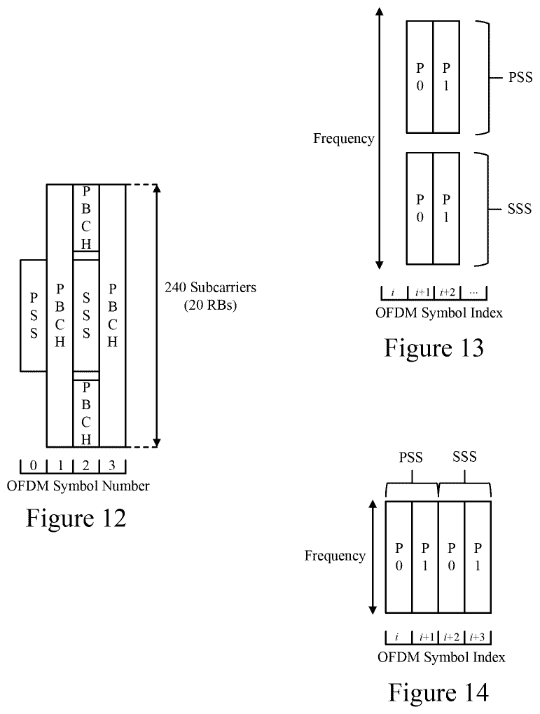

FIG. 12 illustrates an example of an SSB in 5G NR. In 5G NR, the SSB spans 20 resource blocks (RBs) each comprising 12 subcarriers for a total of 240 subcarriers. The SSB includes a Primary Synchronization Signal (PSS) at the first OFDM symbol (symbol 0) and a Secondary Synchronization Signal (SSS) at the third OFDM symbol (symbol 2). Each of the PSS and SSS span 127 subcarriers. The PBCH occupies a total of 576 subcarriers across three OFDM symbols: 240 subcarriers in symbols 1 and 3, and 48 subcarriers in two blocks at symbol number 2.

It is possible to implement a two-stage search method with the first stage using a uniform sampling in the angular domain followed by a second stage using non-uniform sampling in the distance domain. However, it is unlikely to be possible to cover the full distance range in a given azimuth with a single beam, especially in the near field of an antenna array.

One possible solution for beam search and beam training is to cover a large region by transmitting an SSB simultaneously on multiple overlapping beams having the same time and frequency resources within the near field of an antenna array using a transmit diversity scheme as discussed above for data transmissions. By transmitting an SSB on multiple beams with the same azimuth but with beam peaks at different distances, the full distance range can be covered at a given azimuth, and by transmitting an SSB on multiple beams with the same distance but with beam peaks at different azimuths, the full azimuth range can be covered at a given distance. Accordingly, a two-stage search method over azimuth and distance is feasible by transmitting the SSB simultaneously on multiple beams. In some embodiments, hierarchical search methods which split larger beams into smaller beams may be implemented in a straightforward manner when the larger beams are comprised of multiple smaller beams.

As discussed above, when transmitting the same signal on overlapping beams, there is a potential problem in the beam overlap region because the beams may add out of phase and cancel. This problem may be addressed for data transmission by using SFBC or a combination of SFBC and FSTD.

However, the problem is slightly different for an SSB which has multiple parts as seen in FIG. 12. The three parts of the SSB are the PBCH, the PSS, and the SSS. The PBCH can be treated as data and transmitted from multiple beams using SFBC as discussed above and illustrated with respect to FIGS. 5 to 9. Thus, the same SFBC port assignments used for data transmission as discussed with respect to those figures can also be used to transmit the PBCH of an SSB.

The PSS and SSS are different from the PBCH. The PBCH is a data channel, but the PSS and SSS are not data channels. Instead, each of the PSS and SSS comprises a sequence selected from a set of predefined sequences. Furthermore, there are no reference symbols that can be used to estimate the channel prior to the detection of these sequences. As a result, there are challenges associated with using transmit diversity schemes such as SFBC or a combination of SFBC and FSTD to transmit the PSS and SSS.

In embodiments of the present disclosure, ports may be assigned to beams for SSB transmission in the same manner as discussed above for data transmission. In addition, the PSS and SSS can be transmitted using different time and frequency resources that respectively correspond to the port assignments of the associated beams. UEs 104 may scan the time and frequency resources allocated for PSS and the SSS and combine these measurements to extract cell ID information in those signals. The PBCH may be transmitted using SFBC as discussed above.

In order to minimize cancellation of signals in the beam overlap region, the beams can be partitioned into two sets corresponding to port 0 and port 1 in the same manner as for SFBC transmission of data. FIGS. 13 and 14 illustrate examples of allocating time and frequency resources for the transmission of the PSS and SSS transmitted from the two ports.

In FIG. 13, the PSS and SSS for each port are transmitted in the same OFDM symbols, but in different frequency blocks. As seen in FIG. 13, for a beam mapped to port P0, the PSS and SSS are transmitted in a first symbol index (i+1), and for a beam mapped to port P1, the PSS and SSS are transmitted in a second symbol index (i+2) at the same frequencies as the beam mapped to port P0. A UE 104 may scan the allocated frequencies for both symbols for the PSS and SSS and receive the PSS and SSS regardless of whether the UE receives a beam mapped to port P0 or a beam mapped to port P1.

In FIG. 14, the PSS and SSS are transmitted in the same frequency block, but in different OFDM symbols. For a beam mapped to port P0, the PSS is transmitted in symbol indices i and i+2, respectively, at the same frequencies, and the SSS is transmitted in symbol indices i+1 and i+3, respectively, at the same frequencies as the PSS. A UE 104 may scan the four different symbol indices at the same frequencies to receive both the PSS and SSS regardless of whether a beam is mapped to port P0 or port P1.

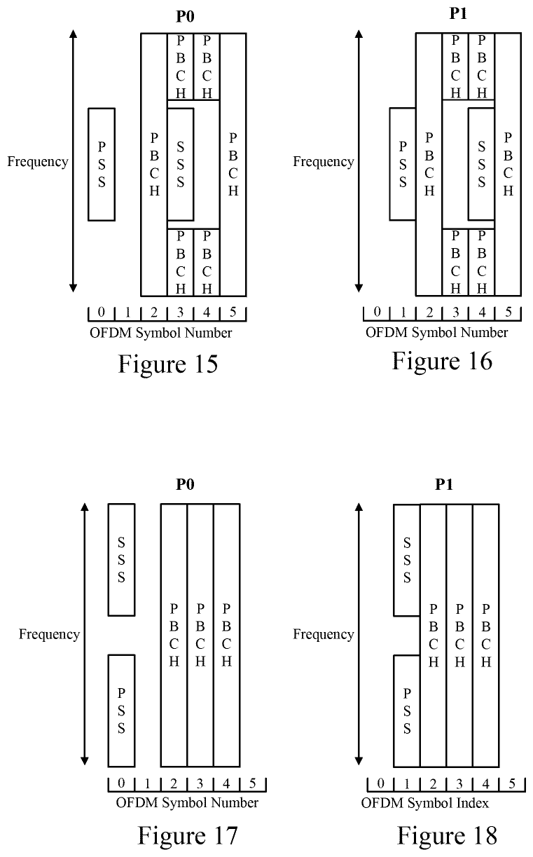

FIGS. 15 and 16 illustrate examples of transmitting the PSS and SSS of an SSB using the same frequency resources and different symbols for each instance of the PSS and SSS. FIG. 15 shows an SSB of a beam mapped to port P0. In the beam of FIG. 15, the PSS is in OFDM symbol 0 and the SSS is in OFDM symbol 3, and the PSS and SSS share the same frequencies. FIG. 16 shows an SSB of a beam mapped to port P1 in which the PSS is in OFDM symbol 1 and the SSS is in OFDM symbol 4. These beams may be transmitted simultaneously as seen in FIGS. 7 to 9, and the PBCH portions of the SSB may be transmitted using SFBC as illustrated in FIGS. 5 and 6.

FIGS. 17 and 18 illustrate examples of transmitting the PSS and SSS of an SSB using different frequencies and the same symbols for each instance of the SSS and PSS. FIG. 17 shows an SSB of a beam mapped to port P0, and the SSS and PSS both occupy OFDM symbol 0 at different frequencies. For the beam mapped to port P1 in FIG. 18, the SSS and PSS both occupy OFDM symbol 1 at the same respective frequencies as the SSB of FIG. 17. These beams may be transmitted simultaneously as seen in FIGS. 7 to 9, and the PBCH portions of the SSB may be transmitted using SFBC as illustrated in FIGS. 5 and 6.

The SSBs of FIGS. 15 to 18 are merely examples of how an SSB may be constructed and are not limiting. Numerous other arrangements are possible within the scope of the present disclosure.

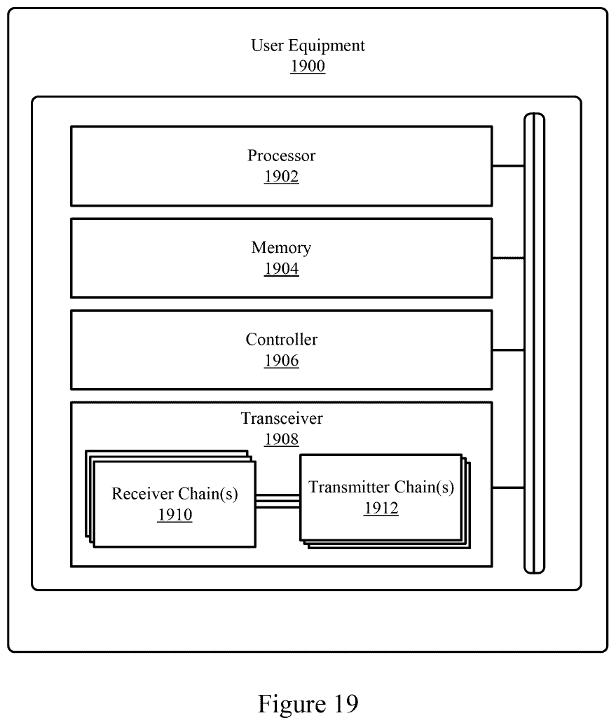

FIG. 19 illustrates an example of a UE 1900 in accordance with aspects of the present disclosure. The UE 1900 may include a processor 1902, a memory 1904, a controller 1906, and a transceiver 1908. The processor 1902, the memory 1904, the controller 1906, or the transceiver 1908, or various combinations thereof or various components thereof may be examples of means for performing various aspects of the present disclosure as described herein. These components may be coupled (e.g., operatively, communicatively, functionally, electronically, electrically) via one or more interfaces.

The processor 1902, the memory 1904, the controller 1906, or the transceiver 1908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1902 may include an intelligent hardware device (e.g., a general-purpose processor, a DSP, a CPU, an ASIC, an FPGA, or any combination thereof). In some implementations, the processor 1902 may be configured to operate the memory 1904. In some other implementations, the memory 1904 may be integrated into the processor 1902. The processor 1902 may be configured to execute computer-readable instructions stored in the memory 1904 to cause the UE 1900 to perform various functions of the present disclosure.

The memory 1904 may include volatile or non-volatile memory. The memory 1904 may store computer-readable, computer-executable code including instructions when executed by the processor 1902 cause the UE 1900 to perform various functions described herein. The code may be stored in a non-transitory computer-readable medium such the memory 1904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1902 and the memory 1904 coupled with the processor 1902 may be configured to cause the UE 1900 to perform one or more of the functions described herein (e.g., executing, by the processor 1902, instructions stored in the memory 1904). For example, the processor 1902 may support wireless communication at the UE 1900 in accordance with examples as disclosed herein. The UE 1900 may be configured to support a means for receiving at least one synchronization signal block (SSB) over a beam within a near field of an antenna array.

The controller 1906 may manage input and output signals for the UE 1900. The controller 1906 may also manage peripherals not integrated into the UE 1900. In some implementations, the controller 1906 may utilize an operating system such as iOS®, ANDROID®, WINDOWS®, or other operating systems. In some implementations, the controller 1906 may be implemented as part of the processor 1902.

In some implementations, the UE 1900 may include at least one transceiver 1908. In some other implementations, the UE 1900 may have more than one transceiver 1908. The transceiver 1908 may represent a wireless transceiver. The transceiver 1908 may include one or more receiver chains 1910, one or more transmitter chains 1912, or a combination thereof.

A receiver chain 1910 may be configured to receive signals (e.g., control information, data, packets) over a wireless medium. For example, the receiver chain 1910 may include one or more antennas for receiving the signal over the air or wireless medium. The receiver chain 1910 may include at least one amplifier (e.g., a low-noise amplifier (LNA)) configured to amplify the received signal. The receiver chain 1910 may include at least one demodulator configured to demodulate the received signal and obtain the transmitted data by reversing the modulation technique applied during transmission of the signal. The receiver chain 1910 may include at least one decoder for decoding the demodulated signal to receive the transmitted data.

A transmitter chain 1912 may be configured to generate and transmit signals (e.g., control information, data, packets). The transmitter chain 1912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1912 may also include at least one power amplifier configured to amplify the modulated signal to an appropriate power level suitable for transmission over the wireless medium. The transmitter chain 1912 may also include one or more antennas for transmitting the amplified signal into the air or wireless medium.

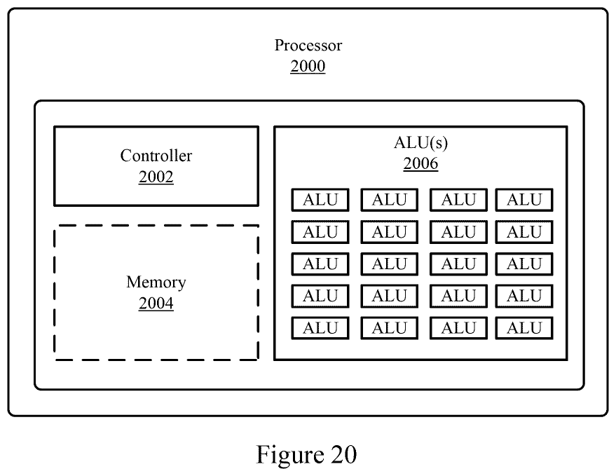

FIG. 20 illustrates an example of a processor 2000 in accordance with aspects of the present disclosure. The processor 2000 may be an example of a processor configured to perform various operations in accordance with examples as described herein. The processor 2000 may include a controller 2002 configured to perform various operations in accordance with examples as described herein. The processor 2000 may optionally include at least one memory 2004, which may be, for example, an L1/L2/L3 cache. Additionally, or alternatively, the processor 2000 may optionally include one or more arithmetic-logic units (ALUs) 2006. One or more of these components may be in electronic communication or otherwise coupled (e.g., operatively, communicatively, functionally, electronically, electrically) via one or more interfaces (e.g., buses).

The processor 2000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 2000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 2002 may be configured to manage and coordinate various operations (e.g., signaling, receiving, obtaining, retrieving, transmitting, outputting, forwarding, storing, determining, identifying, accessing, writing, reading) of the processor 2000 to cause the processor 2000 to support various operations in accordance with examples as described herein. For example, the controller 2002 may operate as a control unit of the processor 2000, generating control signals that manage the operation of various components of the processor 2000. These control signals include enabling or disabling functional units, selecting data paths, initiating memory access, and coordinating timing of operations.

The controller 2002 may be configured to fetch (e.g., obtain, retrieve, receive) instructions from the memory 2004 and determine subsequent instruction(s) to be executed to cause the processor 2000 to support various operations in accordance with examples as described herein. The controller 2002 may be configured to track memory address of instructions associated with the memory 2004. The controller 2002 may be configured to decode instructions to determine the operation to be performed and the operands involved. For example, the controller 2002 may be configured to interpret the instruction and determine control signals to be output to other components of the processor 2000 to cause the processor 2000 to support various operations in accordance with examples as described herein. Additionally, or alternatively, the controller 2002 may be configured to manage flow of data within the processor 2000. The controller 2002 may be configured to control transfer of data between registers, arithmetic logic units (ALUs), and other functional units of the processor 2000.

The memory 2004 may include one or more caches (e.g., memory local to or included in the processor 2000 or other memory, such RAM, ROM, DRAM, SDRAM, SRAM, MRAM, flash memory, etc. In some implementations, the memory 2004 may reside within or on a processor chipset (e.g., local to the processor 2000). In some other implementations, the memory 2004 may reside external to the processor chipset (e.g., remote to the processor 2000).

The memory 2004 may store computer-readable, computer-executable code including instructions that, when executed by the processor 2000, cause the processor 2000 to perform various functions described herein. The code may be stored in a non-transitory computer-readable medium such as system memory or another type of memory. The controller 2002 and/or the processor 2000 may be configured to execute computer-readable instructions stored in the memory 2004 to cause the processor 2000 to perform various functions. For example, the processor 2000 and/or the controller 2002 may be coupled with or to the memory 2004, the processor 2000, the controller 2002, and the memory 2004 may be configured to perform various functions described herein. In some examples, the processor 2000 may include multiple processors and the memory 2004 may include multiple memories. One or more of the multiple processors may be coupled with one or more of the multiple memories, which may, individually or collectively, be configured to perform various functions herein.

The one or more ALUs 2006 may be configured to support various operations in accordance with examples as described herein. In some implementations, the one or more ALUs 2006 may reside within or on a processor chipset (e.g., the processor 2000). In some other implementations, the one or more ALUs 2006 may reside external to the processor chipset (e.g., the processor 2000). One or more ALUs 2006 may perform one or more computations such as addition, subtraction, multiplication, and division on data. For example, one or more ALUs 2006 may receive input operands and an operation code, which determines an operation to be executed. One or more ALUs 2006 be configured with a variety of logical and arithmetic circuits, including adders, subtractors, shifters, and logic gates, to process and manipulate the data according to the operation. Additionally, or alternatively, the one or more ALUs 2006 may support logical operations such as AND, OR, exclusive-OR (XOR), not-OR (NOR), and not-AND (NAND), enabling the one or more ALUs 2006 to handle conditional operations, comparisons, and bitwise operations.

The processor 2000 may support wireless communication in accordance with examples as disclosed herein. The processor 2000 may be configured to or operable to support a means for simultaneously transmitting at least one SSB over a plurality of beams.

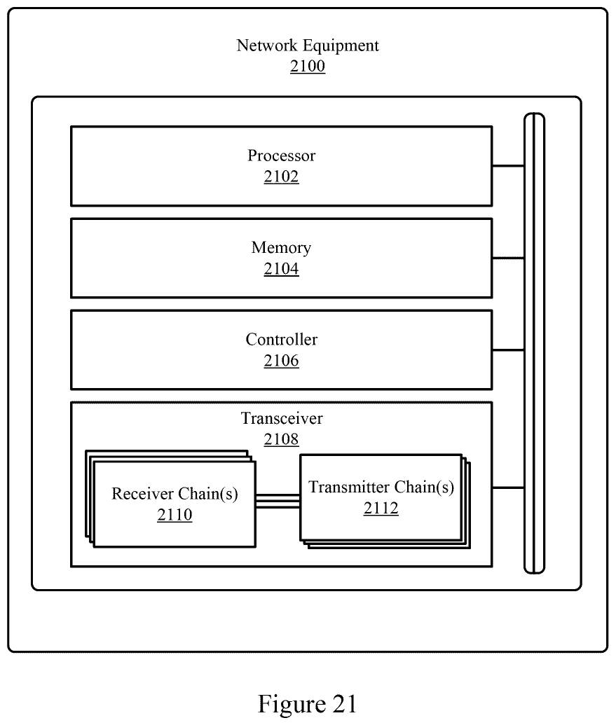

FIG. 21 illustrates an example of a NE 2100 in accordance with aspects of the present disclosure. The NE 2100 may include a processor 2102, a memory 2104, a controller 2106, and a transceiver 2108. The processor 2102, the memory 2104, the controller 2106, or the transceiver 2108, or various combinations thereof or various components thereof may be examples of means for performing various aspects of the present disclosure as described herein. These components may be coupled (e.g., operatively, communicatively, functionally, electronically, electrically) via one or more interfaces.

The processor 2102, the memory 2104, the controller 2106, or the transceiver 2108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 2102 may include an intelligent hardware device (e.g., a general-purpose processor, a DSP, a CPU, an ASIC, an FPGA, or any combination thereof). In some implementations, the processor 2102 may be configured to operate the memory 2104. In some other implementations, the memory 2104 may be integrated into the processor 2102. The processor 2102 may be configured to execute computer-readable instructions stored in the memory 2104 to cause the NE 2100 to perform various functions of the present disclosure.

The memory 2104 may include volatile or non-volatile memory. The memory 2104 may store computer-readable, computer-executable code including instructions when executed by the processor 2102 cause the NE 2100 to perform various functions described herein. The code may be stored in a non-transitory computer-readable medium such the memory 2104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2102 and the memory 2104 coupled with the processor 2102 may be configured to cause the NE 2100 to perform one or more of the functions described herein (e.g., executing, by the processor 2102, instructions stored in the memory 2104). For example, the processor 2102 may support wireless communication at the NE 2100 in accordance with examples as disclosed herein. The NE 2100 may be configured to support a means for simultaneously transmitting at least one SSB over a plurality of beams.

The controller 2106 may manage input and output signals for the NE 2100. The controller 2106 may also manage peripherals not integrated into the NE 2100. In some implementations, the controller 2106 may utilize an operating system such as iOS®, ANDROID®, WINDOWS®, or other operating systems. In some implementations, the controller 2106 may be implemented as part of the processor 2102.

In some implementations, the NE 2100 may include at least one transceiver 2108. In some other implementations, the NE 2100 may have more than one transceiver 2108. The transceiver 2108 may represent a wireless transceiver. The transceiver 2108 may include one or more receiver chains 2110, one or more transmitter chains 2112, or a combination thereof.

A receiver chain 2110 may be configured to receive signals (e.g., control information, data, packets) over a wireless medium. For example, the receiver chain 2110 may include one or more antennas for receiving the signal over the air or a wireless medium. The receiver chain 2110 may include at least one amplifier (e.g., a low-noise amplifier (LNA)) configured to amplify the received signal. The receiver chain 2110 may include at least one demodulator configured to demodulate the received signal and obtain the transmitted data by reversing the modulation technique applied during transmission of the signal. The receiver chain 2110 may include at least one decoder for decoding the demodulated signal to receive the transmitted data.

A transmitter chain 2112 may be configured to generate and transmit signals (e.g., control information, data, packets). The transmitter chain 2112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 2112 may also include at least one power amplifier configured to amplify the modulated signal to an appropriate power level suitable for transmission over the wireless medium. The transmitter chain 2112 may also include one or more antennas for transmitting the amplified signal into the air or wireless medium.

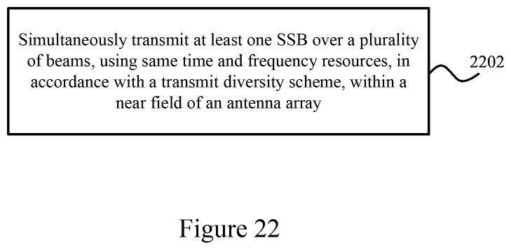

FIG. 22 illustrates a flowchart of a method in accordance with aspects of the present disclosure. The operations of the method may be implemented by a NE as described herein. In some implementations, the NE may execute a set of instructions to control the function elements of the NE to perform the described functions.

At 2202, the method may include simultaneously transmitting at least one synchronization signal block (SSB) over a plurality of beams, using same time and frequency resources, in accordance with a transmit diversity scheme, within a near field of an antenna array. The operations of 2202 may be performed in accordance with examples as described herein. In some implementations, aspects of the operations of 2202 may be performed by a NE as described with reference to FIG. 21.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A base station for wireless communication, comprising:
at least one memory; and
at least one processor coupled with the at least one memory and configured to cause the base station to:
simultaneously transmit at least one synchronization signal block (SSB) over a plurality of beams, using same time and frequency resources, in accordance with a transmit diversity scheme, within a near field of an antenna array.

2. The base station of claim 1, wherein the transmit diversity scheme is Space Frequency Block Coding (SFBC), and wherein the SFBC is exclusively applicable for a Physical Broadcast Channel (PBCH) associated with the at least one SSB.

3. The base station of claim 2, wherein each of the plurality of beams is associated with an SFBC port.

4. The base station of claim 1, wherein the at least one processor is further configured to cause the base station to:
transmit, for each beam of the plurality of beams, a Primary Synchronization Signal (PSS) of the at least one SSB using at least on set of time and frequency resources of at least two sets of time and frequency resources, wherein each set of time and frequency resources is different.

5. The base station of claim 4, wherein the at least one processor is further configured to cause the base station to:
select the at least one set of time and frequency resources based at least in part on an SFBC port associated with each respective beam of the plurality of beams.

6. The base station of claim 5, wherein:
the at least two sets of time and frequency resources are associated with one or more same time resources and different frequency resources,
the time resources comprise one or more symbols or slots, and
the frequency resources comprise one or more frequency sub-bands or frequency bands.

7. The base station of claim 5, wherein:
the at least two sets of time and frequency resources are associated with one or more same frequency resources and different time resources,
the frequency resources comprise one or more frequency sub-bands or frequency bands, and
the time resources comprise one or more symbols or slots.

8. The base station of claim 1, wherein the at least one processor is further configured to cause the base station to:
transmit, for each beam of the plurality of beams, a Secondary Synchronization Signal (SSS) of the at least one SSB using at least one set of time and frequency resources of at least two sets of time and frequency resources, wherein each set of time and frequency resources is different.

9. The base station of claim 8, wherein the at least one processor is further configured to cause the base station to:
select the at least one set of time and frequency resources based at least in part on an SFBC port associated with each respective beam of the plurality of beams.

10. The base station of claim 9, wherein:
the at least two sets of time and frequency resources are associated with one or more same time resources and different frequency resources,
the time resources comprise one or more symbols or slots, and
the frequency resources comprise one or more frequency sub-bands or frequency bands.

11. The base station of claim 9, wherein:
the at least two sets of time and frequency resources are associated with one or more same frequency resources and different time resources,
the frequency resources comprise one or more frequency sub-bands or frequency bands, and
the time resources comprise one or more symbols or slots.

12. A method performed by base station, the method comprising:
simultaneously transmitting at least one synchronization signal block (SSB) over a plurality of beams, using same time and frequency resources, in accordance with a transmit diversity scheme, within a near field of an antenna array.

13. The method of claim 12, wherein the transmit diversity scheme is Space Frequency Block Coding (SFBC), and wherein the SFBC is exclusively applicable for a Physical Broadcast Channel (PBCH) associated with the at least one SSB.

14. The method of claim 12, wherein each of the plurality of beams is associated with an SFBC port.

15. The method of claim 12, further comprising:
transmitting, for each beam of the plurality of beams, a Primary Synchronization Signal (PSS) of the at least one SSB using at least on set of time and frequency resources of at least two sets of time and frequency resources, wherein each set of time and frequency resources is different.

16. The method of claim 15, further comprising:
selecting the at least one set of time and frequency resources based at least in part on an SFBC port associated with each respective beam of the plurality of beams.

17. The method of claim 12, further comprising:
transmitting, for each beam of the plurality of beams, a Secondary Synchronization Signal (SSS) of the at least one SSB using at least one set of time and frequency resources of at least two sets of time and frequency resources, wherein each set of time and frequency resources is different.

18. The method of claim 17, further comprising:
selecting the at least one set of time and frequency resources based at least in part on an SFBC port associated with each respective beam of the plurality of beams.

19. A processor for wireless communication, comprising:
at least one controller coupled with at least one memory and configured to cause the processor to:
simultaneously transmit at least one synchronization signal block (SSB) over a plurality of beams, using same time and frequency resources, in accordance with a transmit diversity scheme, within a near field of an antenna array.

20. The processor of claim 19, wherein the transmit diversity scheme is Space Frequency Block Coding (SFBC), and wherein the SFBC is exclusively applicable for a Physical Broadcast Channel (PBCH) associated with the at least one SSB.
